(19) United States
(12) Patent Application Publication
(10) Pub. No.: US 2010/0071216 A1
(43) Pub. Date: Mar. 25, 2010

(54) SERRATED SNAP-OFF UTILITY KNIFE BLADE

(76) Inventor: Joseph Thomas NOVAK, East Longmeadow, MA (US)

Correspondence Address: MCCARTER & ENGLISH, LLP HARTFORD;CITYPLACE I, 185 ASYLUM STREET, HARTFORD, CT, 06103, US

(21) Appl. No.: 12/235,441

(22) Filed: Sep. 22, 2008

(51) Int. Cl. B26B 1/08; B26B 9/00; B26B 9/02

(52) U.S. Cl. 30/162; 30/335; 30/346.56; 30/349

(57) ABSTRACT

A utility knife blade comprising a blade body defining a first side, a second side opposite the first side, a back edge and a cutting edge opposite the back edge. The cutting edge includes a plurality of serrated portions and substantially non-serrated portions. The blade further defines two opposing lateral edges extending between the back edge and the cutting edge. A plurality of score lines laterally spaced relative to each other along the cutting edge extend across at least one of the first and second sides of the blade between the cutting edge and the back edge, the score lines defining a plurality of blade segments therebetween. The score lines extend between the non-serrated portions of the cutting edge and the back edge so that the serrated portions avoid contact with the score lines to facilitate the breaking off of each cutting segment when desired.

### FIELD OF THE INVENTION

The present invention relates to snap-off utility knife blades having one or more score lines that allow a user to snap off a dulled blade segment in a relatively precise location and, more particularly, to snap-off utility knife blades having serrated portions and non-serrated portions along the cutting edge.

### BACKGROUND

Conventional snap-off utility knives have many uses, for example, opening boxes, cutting rope or strapping, or cutting wallboard or cardboard. The knives employ an elongated blade body having a straight cutting edge. The blade body is further divided into a plurality of segments separated by score lines, thus enabling the leading segment to be snapped or broken off at the respective score line when the segment becomes dulled or worn to provide a user with a new leading segment.

Known types of knife blades have incorporated serrations along the cutting edge in the form of sharpened recessed curves. The serrations improve cutting performance by providing additional cutting points and by effectively increasing the length of the cutting edge in comparison to straight edge blades. Further, the serrations improve cutting edge wear, as the additional cutting points initiate the cut, which effectively reduces the amount of force applied to the sharpened recessed curves that continue the cut. The prior art has not taught the application of serrated cutting edges to snap-off style utility knife blades. One potential drawback associated with applying a serrated cutting edge to a snap-off utility knife blade is that the score lines separating the blade segments would interfere with the serrations, making it difficult to cleanly break off worn blade segments. Furthermore, as a result of this interference, the serrations and cutting points would be damaged upon removal of worn blade segments, diminishing the blade's cutting and penetrating abilities and/or effectively nullifying the advantages that the serrations could provide.

Accordingly, it is an object of the present invention to provide an improved snap-off utility knife blade that incorporates serrations along the cutting edge for enhanced cutting performance.

### SUMMARY OF THE INVENTION

In accordance with a first aspect, the present invention is directed to a utility knife blade comprising a first side, a second side opposite the first side, a back edge, and a plurality of score lines laterally spaced relative to each other along the blade. The score lines define blade segments therebetween that are breakable at each respective score line. The blade further comprises a cutting edge opposite the back edge, which defines a plurality of serrated portions and substantially non-serrated portions. At least a plurality of the score lines extend from approximately the back edge to approximately the cutting edge and intersect the cutting edge at respective non-serrated portions.

In some embodiments, the utility knife blade further defines a plurality of cutting tips. At least one of the cutting tips extends between a front side edge of the blade and an adjacent serrated portion spaced inwardly from the front side edge, and a plurality of other cutting tips extend between respective serrated portions and are located at the intersections of respective score lines and the cutting edge.

In some embodiments, the utility knife blade further defines a plurality of notches formed in the blade at the juncture of each score line and the back edge of the blade to facilitate the breaking off of a respective cutting segment.

In some embodiments, the score lines are located on both the first and second sides of the blade and are positioned such that the score lines on the first side are substantially aligned with the score lines on the second side.

In some embodiments, the serrated portions define a plurality of serrations, each having an apex and, in a direction transverse to the cutting edge of the blade, a thickness that progressively decreases in a direction from the apex to a base of the cutting edge.

In some embodiments, each serration defines a curvilinear boundary region extending on opposite sides of the apex in the direction from the apex toward the base of the cutting edge, and a pair of side surfaces on opposite sides of the cutting edge relative to each other. Further, in some embodiments, each side surface is least one of (i) substantially concave and (ii) substantially planar.

In some embodiments, the utility knife blade further comprises at least one utility knife handle engaging feature for engaging a utility knife handle and allowing movement of the blade relative to the utility knife handle.

In accordance with another aspect, the present invention is directed to a utility knife blade comprising a first side, a second side opposite the first side, a back edge, and a plurality of score lines laterally spaced relative to each other along the blade. The score lines define blade segments therebetween that are breakable at the score lines. The blade further comprises a cutting edge opposite the back edge, which defines a plurality of serrated portions and substantially non-serrated portions. At least a plurality of the score lines extend from approximately the back edge to the cutting edge and intersect the cutting edge at respective non-serrated portions. The blade further comprises first and second metal portions. The first metal portion extends between the back edge and the second metal portion and is formed of a steel defining a first hardness that is preferably within the range of approximately 38 Rc to approximately 52 Rc. The second metal portion defines the cutting edge and is formed of a tool steel defining a second hardness that is greater than the first hardness and is preferably within the range of approximately 60 Rc to approximately 75 Rc. The blade also defines a weld region joining the first and second metal portions. In some such embodiments, the first hardness of the first metal portion is within the range of approximately 40 Rc to approximately 46 Rc, and the second hardness of the second metal portion is within the range of approximately 64 Rc to approximately 67 Rc.

In accordance with another aspect, the present invention is directed to a utility knife blade comprising a first side and a second side opposite the first side, a first edge and a second edge opposite the first edge, a back edge, a cutting edge located on an opposite side of the blade relative to the back edge. The blade further comprises a plurality of blade segments formed adjacent to each other and extending along at least a substantial portion of a length of the blade. Further, the blade comprises a plurality of first means axially spaced relative to each other along the cutting edge; a plurality of second means axially spaced relative to each other and intersecting the cutting edge at respective first means for defining the boundaries between adjacent blade segments and for enabling the breaking off and removal of respective blade segments; and a plurality of third means substantially different than the first means and extending axially along the cutting edge between respective first means for improving at least one of the cutting speed and wear resistance of the cutting edge.

In some embodiments, each first means is at least one of (i) a substantially straight cutting edge portion and (ii) a substantially non-serrated cutting edge portion; each second means is a score line laterally spaced relative to the other score lines and extending across at least one of the first and second sides of the blade substantially between the cutting edge and the back edge; and each third means is a serration formed on the cutting edge. In some embodiments, the blade further comprising fourth means for engaging a utility knife handle to enable movement of the blade relative to the handle. Further, in some embodiments, the blade comprises fifth means for forming a wear-resistant metal cutting edge defining a hardness within the range of approximately 60 Rc to approximately 75 Rc and extending from approximately the first edge to approximately the second edge and sixth means for forming a metal backing to the fifth means and defining a hardness within the range of approximately 38 Rc to approximately 52 Rc, the sixth means extending between the back edge and the fifth means and extending from approximately the first edge to approximately the second edge. A weld region joining the fifth and sixth means extends throughout an interface between the fifth and sixth means from approximately the first edge to approximately the second edge of the blade.

One advantage of the utility knives of the present invention is that the score lines intersect the substantially straight and/or substantially non-serrated portions of the cutting edge as opposed to the serrated portions of the cutting edge thereby allowing for the clean manual breakage and removal of worn blade segments without damaging the cutting edge of the respective blade segment exposed for use.

Another advantage of the currently preferred embodiments of the present invention is that the blade can be used as a traditional snap-off blade or box cutter whereby a small portion (e.g. one or two blade segments) of the blade extends outwardly of the knife handle so that the leading non-serrated portion can be effectively used for penetrating and cutting a box, for example. Alternatively, the blade can be used as a serrated knife whereby a larger portion of the blade (e.g. several blade segments) can be exposed outwardly of the handle to cut a work piece by, for example, reciprocating the exposed blade segments thereby obtaining the cutting advantages of the serrated portions of the cutting edge.

Yet another advantage of the currently preferred embodiments of the present invention is that the inclusion of serrated portions along the cutting edge improves the overall cutting performance and wear characteristics of the blade as a whole and improves the cutting performance and wear characteristics of each individual blade segment.

Other aspects and advantages of the utility knife blades of the present invention and the currently preferred embodiments thereof will become more readily apparent in view of the following detailed description and accompanying drawings.

### BRIEF DESCRIPTION OF THE DRAWINGS

FIG. 1 is a side elevational view of a first embodiment of a utility knife blade of the present invention.

FIG. 2 is a partial, side elevational view of the utility knife blade of FIG. 1.

FIG. 3 is a partial, cross-sectional view of the utility knife blade taken along line 3-3 of FIG. 2 showing the thickness of the blade above the serrations of the cutting edge of the blade, and the progressively decreasing thickness of the serrations.

FIG. 4 is a side elevational view of the utility knife blade of FIG. 1 mounted in a utility knife handle.

FIG. 5 is a side elevational view of the utility blade of FIG. 1 mounted in a utility knife handle and illustrating the leading segment of the blade broken away from the blade.

FIG. 6 is a side elevational view of another embodiment of a utility knife blade of the present invention including notches or other recesses formed in the back edge of the blade at the intersections of the score lines and back edge to facilitate breakage and removal of the cutting edge segments.

FIG. 7 is a side elevational view of another embodiment of a bi-metal utility knife blade of the present invention including a cutting edge formed by a tool steel wire welded to a blade body formed by a spring steel backing.

### DETAILED DESCRIPTION OF THE CURRENTLY PREFERRED EMBODIMENTS

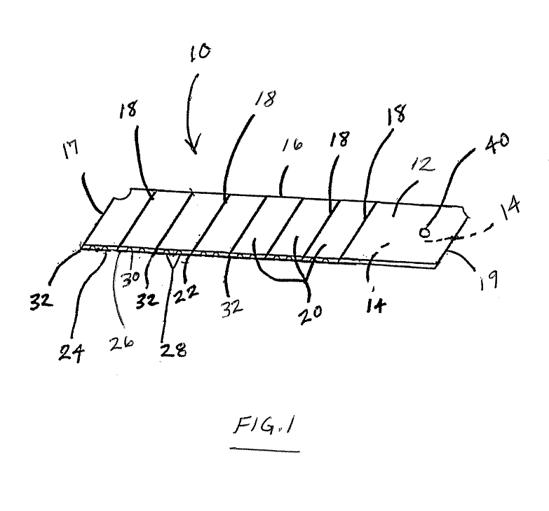

In FIGS. 1-2, an embodiment of the snap-off utility knife blade is indicated generally by the reference numeral 10. The blade 10 comprises a first side 12, a second side 14 opposite the first side, a back edge 16, and a plurality of score lines 18 laterally spaced relative to each other along the blade. The score lines define blade segments 20 therebetween that are breakable at each respective score line. The blade further comprises a cutting edge 22 opposite the back edge 16, and a pair of opposing side edges, first (front) edge 17 and second edge 19. The cutting edge 22 defines a plurality of serrated portions 24 and a plurality substantially non-serrated portions 26. In the illustrated embodiment, the substantially non-serrated portions are substantially straight-edged cutting portions, and the serrated portions 24 define a plurality of serrations 28 in the form of sharpened recessed arc-like curved sections along the cutting edge having a curvilinear periphery. It should be noted, however, that the substantially non-serrated portions need not define straight cutting-edged segments or portions, but rather could define curvilinear, nonlinear or other configurations that are currently known or that later become known. It should also be noted that the serrations 28 can take on any of numerous configurations that are currently known, or that later become known. For example, the serrations could take on a rectilinear, trapezoidal, or triangular configuration or combinations thereof. Further, individual serrations on the cutting edge 22 of a blade 10 can have different configurations with respect to the other serrations. The serrations improve the overall cutting performance of the blade by providing additional cutting points 30 and by effectively increasing the length of the cutting edge 22 in comparison to straight edge blades. Further, the serrations 28 improve cutting edge wear, as the additional cutting points initiate the cut in a workpiece, which effectively reduces the amount of force applied to the sharpened recessed curves that continue the cut.

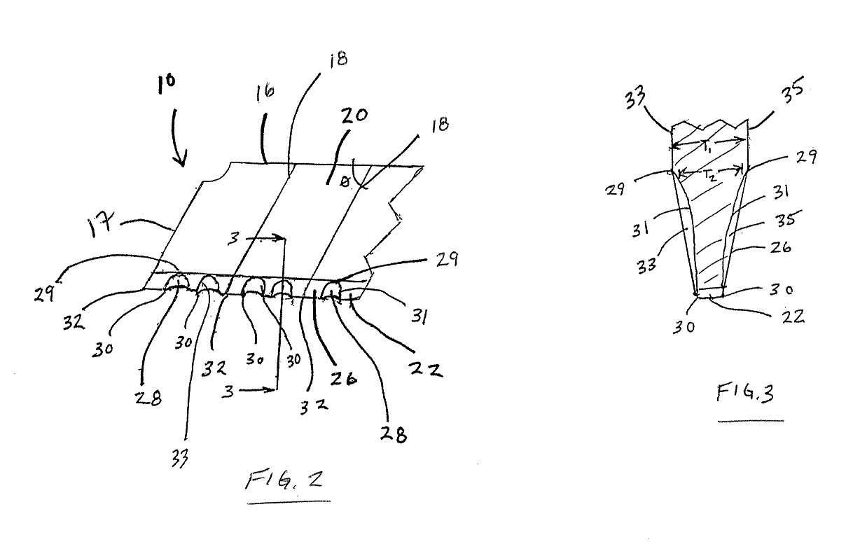

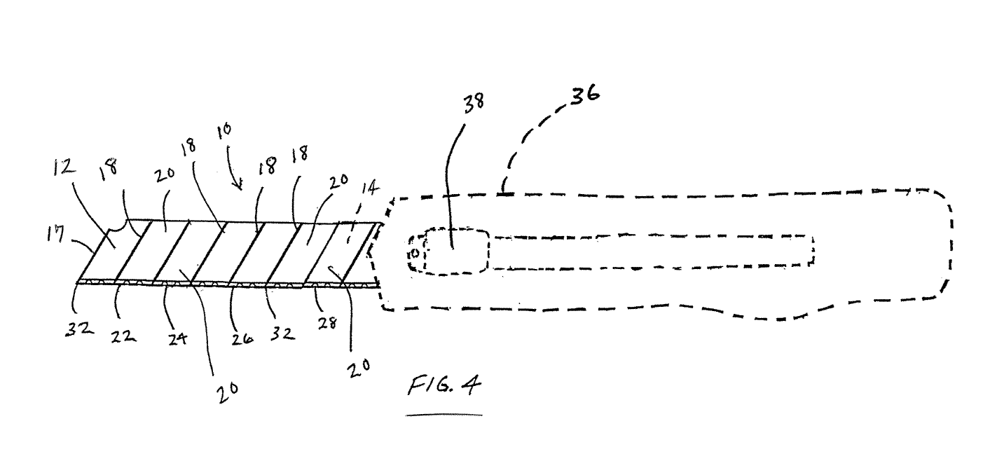

As shown in FIG. 3, in the illustrated embodiment each serrated portion 24 includes a plurality of serrations 28 axially spaced relative to each other. As shown in FIGS. 2 and 3, each serration 28 defines an apex 29, a curvilinear boundary region 31 extending downwardly on opposite sides of the apex to the base of the cutting edge and a pair of side surfaces 33, 35 on opposite sides of the cutting edge relative to each other. As shown in FIG. 3, in a direction transverse to the cutting edge 22 of the blade 10, the portion of the cutting edge located immediately above each serration 28 defines a thickness “T1”, and each serration defines a thickness “T2” that progressively decreases in the direction from the respective apex 29 toward the base of the cutting edge. In the illustrated embodiment, each side surface is substantially concave. However, as may be recognized by those of ordinary skill in the pertinent art based on the teachings herein, the side surfaces of each serration may take on numerous configurations. For example, the side surfaces can be substantially planar, or at least one side surface can be substantially concave while at least one side surface is substantially planar.

In the illustrated embodiment, the score lines 18 extend from approximately the back edge 16 to approximately the cutting edge 22 of the blade 10 and intersect the cutting edge 22 at the non-serrated portions 26. In this manner, the score lines do not interfere with the serrated portions 24 on the blade's cutting edge 22, effectively making it easier for a user to cleanly break off a worn blade segment 20 and avoid damaging the serrations 28 as well as the cutting tips 32 (described in further detail below) of the new blade segments. The score lines 18 intersect the cutting edge 22 at an acute angle • relative to the back edge 16 of the blade. In the illustrated embodiment the angle • is about 60°. Preferably, the angle • is within the range of about 22° to about 82°, and more preferably, is within the range of 32° to about 72°. However, as may be recognized by those of ordinary skill in the pertinent art based on the teachings herein, the score lines may be oriented at any desired angle relative to the back edge or other reference plane. Further, each score has a v-shaped cross-section (not shown), which defines an oblique angle in the range of about 30° degrees to about 120° and, more preferably, between about 60° degrees and about 90°. However, as may be recognized by those of ordinary skill in the pertinent art based on the teachings herein, the score lines may be oriented at any desired angle relative to the back edge or other reference plane, and may take on numerous cross-sectional configurations. In the illustrated embodiment, the score lines 18 are located on both the first side 12 and second side 14 of the blade 10. In this embodiment, the score lines 18 are positioned such that the score lines on the first side 23 are substantially aligned with the score lines on the second side 14. However, as may be recognized by those of ordinary skill in the pertinent art based on the teaching herein, the score lines may be formed on only one side of the blade and/or may define any of numerous different score line configurations that are currently known, or that later become known.

The utility knife blade 10 further comprises a plurality of cutting tips 32 that define substantially straight edge portions extending between the serrated portions 28. More specifically, the lead cutting tip 32 is located at the front corner of the blade and extends between the front or first side edge 17 of the blade and the adjacent serration 28. The other cutting tips 32 are located at the intersection of each score line 18 and the cutting edge 22.

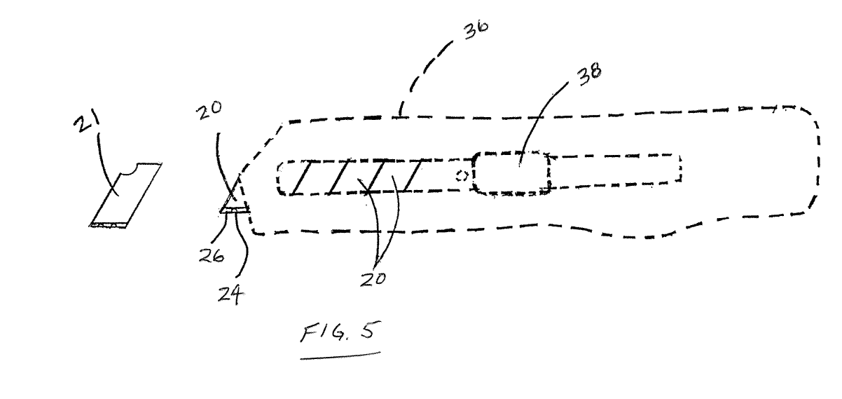

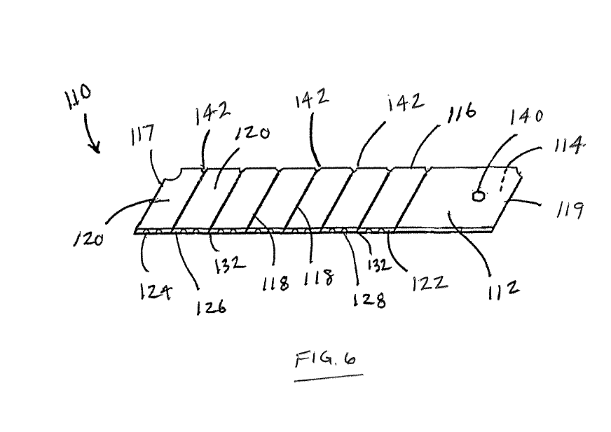

Referring to FIGS. 4-5, the blade 10 is shown in combination with a utility knife blade handle or holder 36. The blade handle 36 is represented in broken lines to provide structure and boundaries only, and should not be interpreted in the limiting sense, as the blade 10 is designed for use in blade handles having numerous shapes, sizes and configurations. The blade handle 36 includes an actuator 38 that engages the blade 10 via at least one utility knife handle engaging feature 40, thereby allowing the blade 10 to move relative to the utility knife handle 36 when the actuator is depressed or engaged by a user. This configuration allows the blade 10 to be used, for example, as a serrated knife (FIG. 4) with the majority of the blade segments extending from the handle 36 or, for example, as a conventional box cutter with only a portion of the leading blade segment exposed from the handle 36 (FIG. 5). As noted above, the blade segments 20 are breakable at their respective score lines (see FIG. 5), so that a blade segment 21 having a dulled cutting edge and/or dulled cutting tip can be removed at a user's discretion to reveal a fresh blade segment 20.

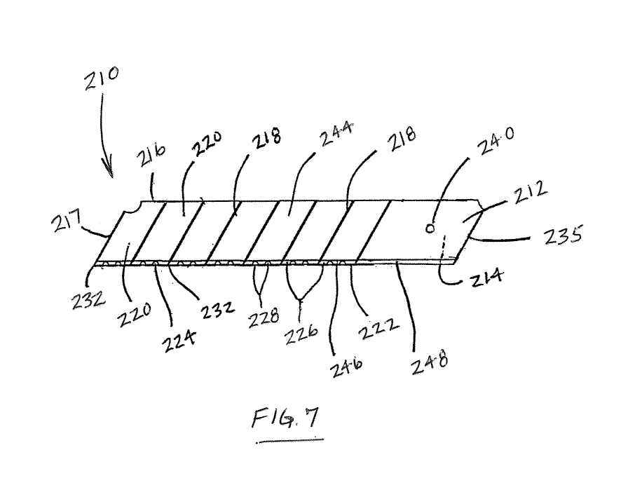

Drawing attention to FIG. 6, another blade embodying the present invention is indicated generally by the reference numeral 110. The blade 110 is substantially similar to the blade 10 described above with reference to FIGS. 1 through 5, and therefore like reference numerals preceded by the numeral “1” are used to indicate like elements. The primary difference of the blade 110 in comparison to the blade 10 is that the blade 110 further defines a plurality of notches 142 formed in the blade 110. The notches 42 are formed at the juncture of each score line 118 and the back edge of the blade 116 and facilitate the breaking off of a respective blade segment without compromising the overall strength and integrity of the blade 10.

With reference to FIG. 7, another blade embodying the present invention is indicated generally by the reference numeral 210. The blade 210 is substantially similar to the blade 10 described above with reference to FIGS. 1 through 5, and therefore like reference numerals preceded by the numeral “2” are used to indicate like elements. The primary difference of the blade 210 in comparison to the blade 10 is that the blade 210 is a composite blade comprising a first metal portion 244 and a second metal portion 246. The first metal portion 244 extends between the back edge 216 and the second metal portion 246 and is formed of a steel heat treated to a first hardness preferably within the range of approximately 38 Rc to approximately 52 Rc. The second metal portion 246 defines the cutting edge 222 and is formed of a tool steel heat treated to a second hardness greater than the first hardness and preferably within the range of approximately 60 Rc to approximately 75 Rc. The blade 210 further defines a weld region 248 joining the first 244 and second 246 metal portions and extends across the interface between the first and second metal portions.

In at least one embodiment, the weld region 248 defines an approximate line of joinder extending from one side edge 217 to the other side edge 219 of the blade. The second metal portion 246 is joined to the first metal portion 244 by applying thermal energy, such as by electron beam welding, to the interface of the metal portions to thereby weld the first metal portion 244 to the second metal portion 244. Further, in at least one embodiment, the first metal portion 244 is treated to a hardness within the range of approximately 40 Rc to approximately 46 Rc and the second metal portion 246 is treated to a hardness within the range of approximately 64 Rc to approximately 67 Rc.

The first metal portion 244 of blade 210 is preferably made of any of numerous different grades of steel capable of being heat treated to a surface hardness within the range of approximately 38 Rc to approximately 52 Rc, such as any of numerous different alloy steels or standard AISI grades, including without limitation 6135, 6150 and D6A. The second metal portion 246, on the other hand, is preferably made of any of numerous different types of wear-resistant steel capable of being heat treated to a surface hardness within the range of approximately 60 Rc to approximately 75 Rc, including any of numerous different tool steels or high-speed steels, such as any of numerous different standard AISI grades, including, without limitation, M Series grades, such as M1, M2, M3, M42, etc., A Series grades, such as A2, A6, A7 A9, etc., H Series grades, such as H10, H11, H12, H13, etc., T Series grades, such as T1, T4, T8, etc., and W, S, O, D and P Series grades. In one embodiment, the first metal portion 244 is formed of an alloy steel strip welded to the second metal portion 246 and heat treated to a hardness within the range of approximately 38 Rc to approximately 52 Rc. Furthermore, the second metal portion 246 is formed of a tool steel wire welded to the first metal portion 244 and heat treated to a hardness within the range of approximately 60 Rc to approximately 75 Rc.

As may be recognized by those skilled in the pertinent art based on the teachings herein, the currently preferred materials used to construct the first and second metal portions 244, 246 disclosed herein are only exemplary, and numerous other types of metals that are currently known or later become known for performing the functions of the first and/or second metal portions may be equally employed to form the composite utility knife blades of the present invention.

Further details of the composite utility blades 100 and the manufacture of such blades are disclosed in the following patent and co-pending patent applications that are assigned to the assignee of the present invention and are hereby expressly incorporated by reference in their entireties as part of the present disclosure: U.S. Pat. No. 6,701,627 issued Mar. 9, 2004, entitled “COMPOSITE UTILITY KNIFE BLADE AND METHOD OF MAKING SUCH A BLADE”; U.S. patent application Ser. No. 10/202,703 filed Jul. 24, 2002, entitled “Composite Utility Knife Blade and Method of Making Such a Blade”; and U.S. patent application Ser. No. 10/793,593 filed Mar. 4, 2004, entitled “COMPOSITE UTILITY BLADE AND METHOD OF MAKING SUCH A BLADE”.

As may be recognized by those skilled in the pertinent art based on the teachings herein, the utility blades 10, 110 and 210 may be made of any of numerous different materials that are currently known or that later become known, such as conventional carbon steels, bi-metal or other composite constructions, and/or may include any of numerous different coatings, such as wear-resistant coatings and/or decorative coatings.

As may be recognized by those skilled in the pertinent art based on the teachings herein, numerous changes and modifications may be made to the above described and other embodiments of the snap-off utility knife blades 10, 110, 210 blades herein described without departing from the scope of the invention as defined in the appended claims. For example, the blades may take any of numerous different shapes and/or configurations that are currently known, or that later become known, and the serrations and/or substantially straight cutting edge portions located between the serrations may take on any of numerous different configurations that are currently known, or that later become known. Accordingly, this detailed description of preferred embodiments is to be taken in an illustrative, as opposed to a limiting sense.

What is claimed is:

1. A utility knife blade comprising:
a first side;
a second side opposite the first side;
a back edge;
a plurality of score lines laterally spaced relative to each other along the blade and defining blade segments therebetween that are breakable at the score lines; and
a cutting edge opposite the back edge, the cutting edge defining a plurality of serrated portions and substantially non-serrated portions located between the serrated portions, wherein at least a plurality of the score lines extend from approximately the back edge to the cutting edge and intersect the cutting edge at respective non-serrated portions.

2. A utility knife blade as defined in claim 1, further defining a plurality of cutting tips, where at least one of the cutting tips extends between a front edge of the blade and an adjacent serrated portion spaced inwardly from the front edge of the blade, and a plurality of other cutting tips extend between respective serrated portions and are located at the intersections of respective score lines and the cutting edge.

3. A utility knife blade as defined in claim 1, further defining a plurality of notches, wherein each notch is formed at the juncture of a respective score line and the back edge of the blade to facilitate the breaking off of a respective cutting segment.

4. A utility knife blade as defined in claim 1, wherein the score lines are located on both the first and second sides of the blade and are positioned such that the score lines on the first side are substantially aligned with the score lines on the second side.

5. A utility knife blade as defined in claim 1, wherein the serrated portions define a plurality of serrations, each having an apex and, in a direction transverse to the cutting edge of the blade, a thickness that progressively decreases in a direction from the apex to a base of the cutting edge.

6. A utility knife blade as defined in claim 5, wherein each serration defines a curvilinear boundary region extending on opposite sides of the apex in the direction from the apex toward the base of the cutting edge, and a pair of side surfaces on opposite sides of the cutting edge relative to each other.

7. A utility knife blade as defined in claim 6, wherein each side surface is least one of (i) substantially concave and (ii) substantially planar.

8. A utility knife blade as defined in claim 1, further comprising at least one utility knife handle engaging feature for engaging a utility knife handle and allowing movement of the blade relative to the utility knife handle.

9. A utility knife blade comprising:
a first side;
a second side opposite the first side;
a back edge;
a plurality of score lines laterally spaced relative to each other along the blade and defining blade segments therebetween that are breakable at the score lines;
a cutting edge opposite the back edge, the cutting edge defining a plurality of serrated portions and substantially non-serrated portions located between serrated portions, wherein at least a plurality of the score lines extend from approximately the back edge to the cutting edge and intersect the cutting edge at respective non-serrated portions;
first and second metal portions, wherein the first metal portion extends between the back edge and the second metal portion and is formed of a steel defining a first hardness, and the second metal portion defines the cutting edge and is formed of a relatively wear-resistant steel defining a second hardness greater than the first hardness; and
a weld region joining the first and second metal portions.

10. A utility knife blade as defined in claim 9, further defining a plurality of cutting tips, where at least one of the cutting tips extends between a front edge of the blade and an adjacent serrated portion spaced inwardly from the front edge of the blade, and a plurality of other cutting tips extend between respective serrated portions and are located at the intersections of respective score lines and the cutting edge.

11. A utility knife blade as defined in claim 9, further defining a plurality of notches, wherein each notch is formed at the juncture of a respective score line and the back edge of the blade to facilitate the breaking off of a respective cutting segment.

12. A utility knife blade as defined in claim 9, wherein the score lines are located on both the first and second sides of the blade and are positioned such that the score lines on the first side are substantially aligned with the score lines on the second side.

13. A utility knife blade as defined in claim 9, wherein the serrated portions define a plurality of serrations, each having an apex and, in a direction transverse to the cutting edge of the blade, a thickness that progressively decreases in a direction from the apex to a base of the cutting edge.

14. A utility knife blade as defined in claim 13, wherein each serration defines a curvilinear boundary region extending on opposite sides of the apex in the direction from the apex toward the base of the cutting edge, and a pair of side surfaces on opposite sides of the cutting edge relative to each other.

15. A utility knife blade as defined in claim 9, further comprising at least one utility knife handle engaging feature for engaging a utility knife handle and allowing movement of the blade relative to the utility knife handle.

16. A utility knife blade as defined in claim 9, wherein the first metal portion is formed of spring steel and defines a first hardness within the range of approximately 38 Rc to approximately 52 Rc, and the second metal portion is formed of tool steel and defines a second hardness within the range of within the range of approximately 60 Rc to approximately 75 Rc.

17. A utility knife blade comprising:
a first side and a second side opposite the first side;
a first edge and a second edge opposite the first edge;
a back edge;
a cutting edge located on an opposite side of the blade relative to the back edge;
a plurality of blade segments formed adjacent to each other and extending along at least a substantial portion of a length of the blade;
a plurality of first means axially spaced relative to each other along the cutting edge;
a plurality of second means axially spaced relative to each other and intersecting the cutting edge at respective first means for defining the boundaries between adjacent blade segments and for enabling the breaking off and removal of respective blade segments; and
a plurality of third means substantially different than the first means and extending axially along the cutting edge between respective first means for improving at least one of the cutting speed and wear resistance of the cutting edge.

18. A utility knife blade as defined in claim 17, wherein each first means is at least one of (i) a substantially straight cutting edge portion and (ii) a substantially non-serrated cutting edge portion, each second means is a score line laterally spaced relative to the other score lines and extending across at least one of the first and second sides of the blade substantially between the cutting edge and the back edge, and each third means is a serration formed on the cutting edge.

19. A utility knife blade as defined in claim 18, wherein each serration defines an apex and, in a direction transverse to the cutting edge of the blade, a thickness that progressively decreases in a direction from the apex to a base of the cutting edge.

20. A utility knife blade as defined in claim 19, wherein each serration defines a curvilinear boundary region extending on opposite sides of the apex in the direction from the apex toward the base of the cutting edge, and a pair of side surfaces on opposite sides of the cutting edge relative to each other.

21. A utility knife blade as defined in claim 17, further comprising fourth means for engaging a utility knife handle to enable movement of the blade relative to the handle.

22. A utility knife as defined in claim 17, further comprising:
fifth means for forming a wear-resistant metal cutting edge defining a hardness within the range of approximately 60 Rc to approximately 75 Rc and extending from approximately the first edge to approximately the second edge;
sixth means for forming a metal backing to the fifth means and defining a hardness within the range of approximately 38 Rc to approximately 52 Rc, the sixth means extending between the back edge and the fifth means and extending from approximately the first edge to approximately the second edge; and
a weld region joining the fifth and sixth means and extending throughout an interface between the fifth and sixth means from approximately the first edge to approximately the second edge of the blade.

23. A utility knife blade as defines in claim 22, wherein the fifth means is formed of a tool steel wire welded to the sixth means and heat treated to a hardness within the range of approximately 60 Rc to approximately 75 Rc, and the sixth means is formed of an alloy steel strip welded to the fifth means and heat treated to a hardness within the range of approximately 38 Rc to approximately 52 Rc.
